(19) United States
(12) Patent Application Publication
(10) Pub. No.: US 2019/0025016 A1
(43) Pub. Date: Jan. 24, 2019

(54) PORTABLE MODULAR AND EXPANDABLE TARGET

(71) Applicant: David Schroedel, Mesa, AZ (US)

(72) Inventor: David Schroedel, Mesa, AZ (US)

(21) Appl. No.: 16/040,421

(22) Filed: Jul. 19, 2018

Related U.S. Application Data
(60) Provisional application No. 62/534,346, filed on Jul. 19, 2017.

(51) Int. Cl. F41J 1/10

(52) U.S. Cl. CPC F41J 1/10; F16M 11/22

(57) ABSTRACT

The various embodiments herein provide a portable modular target stand comprising a primary stabilization rail, a secondary stabilization rail, and a plurality of leg receiving brackets. The primary stabilization rail forms a base for a plurality of accessories and a plurality of target structure. The secondary stabilization rail is housed within the primary stabilization rail. The plurality of leg receiving brackets are connected on the proximal ends of the primary stabilization rail. Each leg receiving bracket is attached with a leg fixed on a ground surface through a fixing mechanism.

### BACKGROUND

### Technical Field of Invention

The embodiments herein generally relate to a mechanical apparatus and particularly relate to a portable, modular and expandable target stand. The embodiments herein more particularly relate to a multiple target stand to hold a plurality of targets with variable weights and assembly design simultaneously for target practice.

### Description of Related Art

The use of rifles, pistols, shotguns, firearms, and the like to shoot bullets or other projectiles at targets designed for that purpose is a common sport, hobby, and pastime for many people. Characteristics of targets used in such activity generally include clearly visible and easily identifiable areas of desired impact, commonly referred to as bullseyes, a means for determining the point of impact of the bullet or projectile, and the ability to change or reset the target. A significant convenience to target shooters is the ability to shoot continuously at the bullseyes without having to manually change or reset the target. For continuous practicing, the shooters use a target stand with multiple targets.

To provide a target stand for various kinds of shooting practices, a plurality of prior art target stands had been developed. One of such prior arts discloses a target for hanging on a frame. The frame has a hanging member further having a first elongated arm, a second arm extending from the first arm and a third arm extending from the second arm. The first and third arms are parallel to each other and the second arm is perpendicular to said first and third arms. The third arm is shorter than the first arm. The hanging member has a thickness. A target disk has an elongated slot and the hanging member is inserted into the slot. The third arm extends through the slot and the second arm is received within the slot.

Another prior art discloses a horizontal stand assembly enables a user to mount a target for shooting which can be easily repaired, relocated or stored. The horizontal stand assembly includes a first bracket connected to a second bracket where each bracket has an offset trapezoidal shape with a front angled cavity which angles backward and is offset from a rear angled cavity which angles frontward such that each bracket can accommodate a front post in the front angled cavity and a rear post in the rear angled cavity. Each bracket further comprises a horizontal cavity such that horizontal posts can be placed through each horizontal cavity connecting the first bracket to the second bracket such that the target can be hung from the horizontal posts without deflecting.

However, the prior arts need to be generally heavy and fixed or non-modular in nature to hold a heavy target or a plurality of targets. On the contrary, if the prior art target stands are modular in nature, they are not strong and versatile enough to support variable bodied targets. Thus, the prior arts prove to be inefficient during carriage of various target practices.

In the view of foregoing, there is a need for a target stand with a modular, portable and expandable assembly and a rigid body structure. Also, there is a need for a target stand to house variable target fixtures in a radial as well as lateral direction.

### SUMMARY OF THE INVENTION

The primary objective of the present invention is to provide a target stand with a modular, portable and expandable assembly and a rigid body structure.

Another objective of the present invention is to provide a target stand to house variable target fixtures in a radial as well as lateral direction.

Yet another objective of the present invention is to provide an expandable target stand with a cascading ability with other target stand in a longitudinal as well as lateral directions.

The various embodiments herein provide a portable modular target stand comprising a primary stabilization rail, a secondary stabilization rail, and a plurality of leg receiving brackets. The primary stabilization rail forms a base for a plurality of accessories and a plurality of target structure. The secondary stabilization rail is housed within the primary stabilization rail. The plurality of leg receiving brackets are connected on the proximal ends of the primary stabilization rail. Each leg receiving bracket is attached with a leg fixed on a ground surface through a fixing mechanism.

According to one embodiment herein, the primary stabilization rail comprises a plurality of slots on a top surface and a plurality of hooks on a front surface.

According to one embodiment herein, the secondary stabilization rail comprises a plurality of slots in line with a plurality of slots in the primary stabilization rail.

According to one embodiment herein, a rear surface of the primary stabilization rail and the secondary stabilization rail is attached to a ballistic resistant metallic plate.

According to one embodiment herein, the primary stabilization rail further comprises a hole with a specifically machined connector on each proximal end for further connecting additional target stands.

According to one embodiment herein, the plurality of legs are vertically protrudeable in nature to increase a height of the primary stabilization rail resulting in vertical adjustment of the target structure.

According to one embodiment herein, the primary stabilization rail, the secondary stabilization rail, the ballistic metallic plate, the plurality of leg receiving brackets and the plurality of legs have a thickness of 0.375 inches.

According to one embodiment herein, the primary stabilization rail, the secondary stabilization rail, the plurality of leg receiving brackets and the plurality of legs are made up of mild steel.

According to one embodiment herein, the primary stabilization rail is connected with another primary stabilization rail of another target stand in a lateral direction as well as longitudinal direction.

According to one embodiment herein, the plurality of accessories and the plurality of target structures are connected to the primary stabilization rail through a locking mechanism comprising a thread locking, a vacuum grip locking, a sliding grip locking, and a plug-in locking.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1a-1d illustrates a side view, a side perspective view, a top perspective view, and a rear perspective view of a target stand respectively, according to one embodiment herein.

FIG. 1e illustrates a side perspective view of the target stand with a plurality of accessories mounted on the target stand, according to one embodiment herein.

FIG. 1f illustrates a side perspective view of the target stand with a plurality of target structures mounted on the target stand, according to one embodiment herein.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a portable modular target stand comprising a primary stabilization rail, a secondary stabilization rail, and a plurality of leg receiving brackets. The primary stabilization rail forms a base for a plurality of accessories and a plurality of target structure. The secondary stabilization rail is housed within the primary stabilization rail. The plurality of leg receiving brackets are connected on the proximal ends of the primary stabilization rail. Each leg receiving bracket is attached with a leg fixed on a ground surface through a fixing mechanism.

According to one embodiment herein, the primary stabilization rail comprises a plurality of slots on a top surface and a plurality of hooks on a front surface.

According to one embodiment herein, the secondary stabilization rail comprises a plurality of slots in line with a plurality of slots in the primary stabilization rail.

According to one embodiment herein, a rear surface of the primary stabilization rail and the secondary stabilization rail is attached to a ballistic resistant metallic plate.

According to one embodiment herein, the primary stabilization rail further comprises a hole with a specifically machined connector on each proximal end for further connecting additional target stands.

According to one embodiment herein, the plurality of legs are vertically protrudeable in nature to increase a height of the primary stabilization rail resulting in vertical adjustment of the target structure.

According to one embodiment herein, the primary stabilization rail, the secondary stabilization rail, the ballistic metallic plate, the plurality of leg receiving brackets and the plurality of legs have a thickness of 0.375 inches.

According to one embodiment herein, the primary stabilization rail, the secondary stabilization rail, the plurality of leg receiving brackets and the plurality of legs are made up of mild steel.

According to one embodiment herein, the primary stabilization rail is connected with another primary stabilization rail of another target stand in a lateral direction as well as longitudinal direction.

According to one embodiment herein, the plurality of accessories and the plurality of target structures are connected to the primary stabilization rail through a locking mechanism comprising a thread locking, a vacuum grip locking, a sliding grip locking, and a plug-in locking.

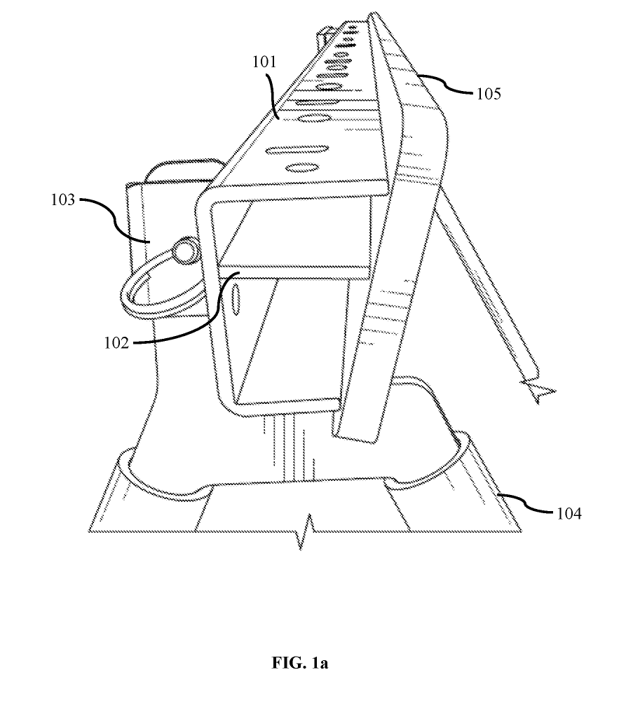

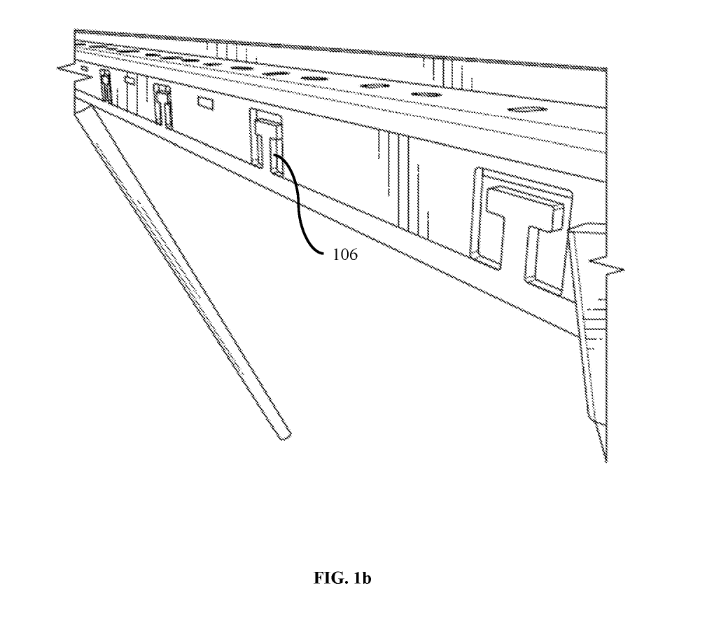

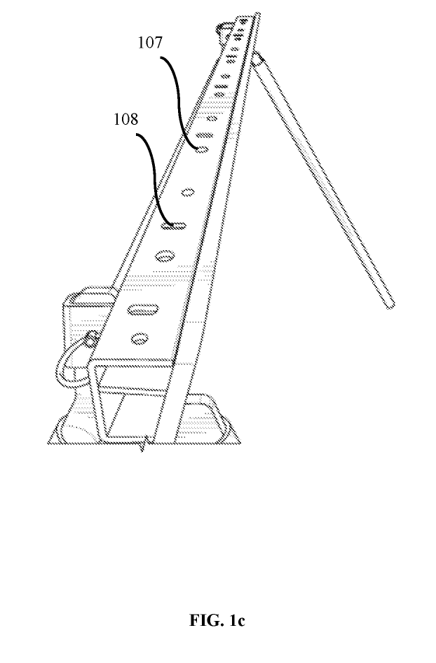

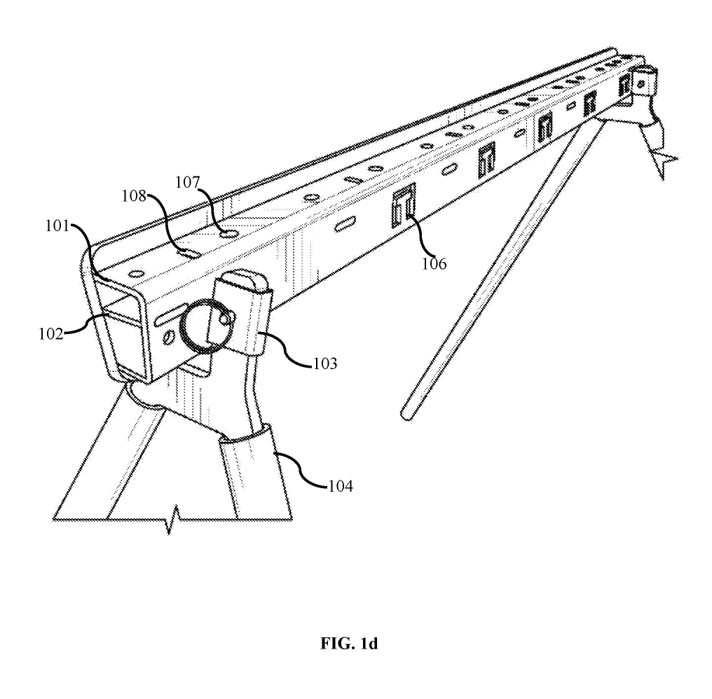

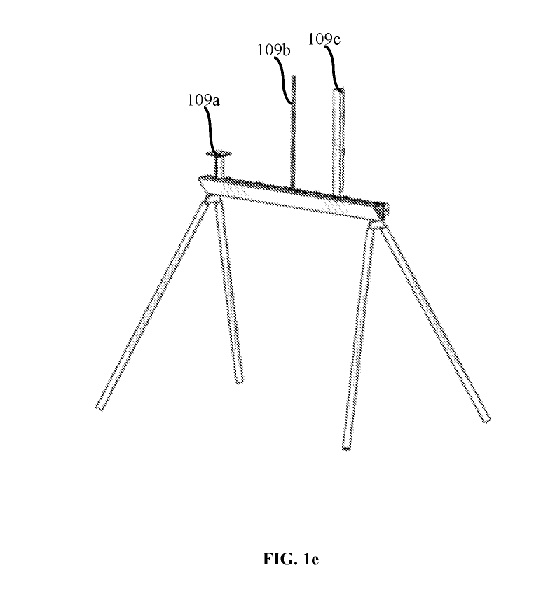

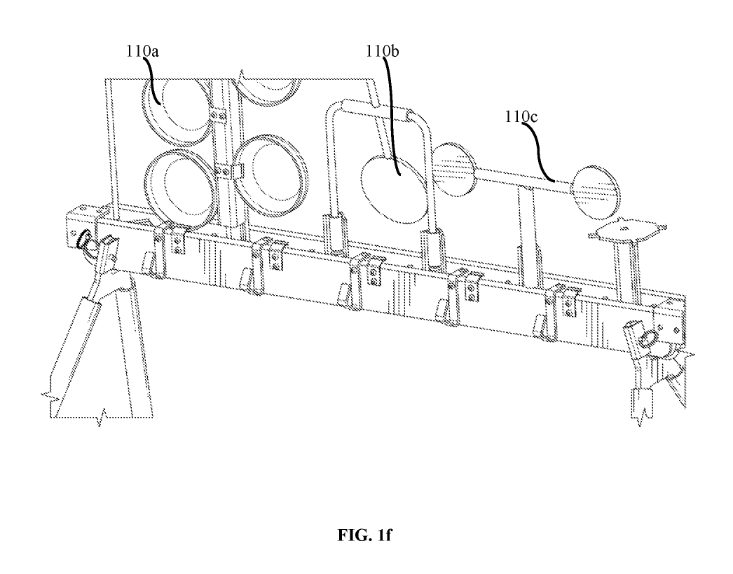

FIG. 1a-1d illustrates a side view, a side perspective view, a top perspective view, and a rear perspective view of a target stand respectively, according to one embodiment herein. With respect to FIG. 1a-1d, the primary stabilization rail (101) in the target stand is a mild steel frame of C-shape or of U-shape. An open end of the primary stabilization rail (101) is welded with a ballistic steel plate (AR500) (105) and is further welded with the secondary stabilization rail (102) present in a mid-section of the primary stabilization rail (101). The welding creates a single structure comprised of the ballistic steel plate (105), the primary stabilization rail (101) and the secondary stabilization rail (102). The primary stabilization rail (101) and the secondary stabilization rail (102) comprises a plurality of holes (107) and slots (108) on a top surface for holding a plurality of target accessories and target structure such as gongs. The primary stabilization rail further comprises a plurality T-shaped hooks (106) for hanging a plurality of target structures. The proximal ends of the ballistic steel plate (105) and the primary stabilization rail (101) is welded with a leg receiving brackets (103) which further support a metallic leg (104) fixed through a removable pin. The legs are firmly clamped on the ground to reduce vibration during the target practice.

FIG. 1e illustrates a side perspective view of the target stand with a plurality of accessories mounted on the target stand, according to one embodiment herein. The plurality of holes (107) and slots (108) in the primary stabilization rail (101) support fixation of rod (109b) with a target structure, a beam (109c) for supporting multiple target structures and a beam base (109a) for increasing height of at-least one target structure.

FIG. 1f illustrates a side perspective view of the target stand with a plurality of target structures mounted on the target stand, according to one embodiment herein. The target structures are extended in lateral direction also by adding horizontal clamps on the beam base or the primary stabilization rail. This increases a scope of target practicing as a user gets multiple adjacent targets (110a), target with increased height, hanging target (110b), rotating targets (110c) and target at variable distance through a single target stand.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A portable modular target stand comprising:
a primary stabilization rail, wherein the primary stabilization rail forms a base for a plurality of accessories and a plurality of target structure;
a secondary stabilization rail, wherein the secondary stabilization rail is housed within the primary stabilization rail; and
a plurality of leg receiving brackets, wherein the plurality of leg receiving brackets are connected on the proximal ends of the primary stabilization rail;
wherein, each leg receiving bracket is attached with a leg fixed on a ground surface through a fixing mechanism.

2. The target stand according to claim 1, wherein the primary stabilization rail comprises a plurality of slots on a top surface and a plurality of hooks on a front surface.

3. The target stand according to claim 1, wherein the secondary stabilization rail comprises a plurality of slots in line with a plurality of slots in the primary stabilization rail.

4. The target stand according to claim 1, wherein a rear surface of the primary stabilization rail and the secondary stabilization rail is attached to a ballistic resistant metallic plate.

5. The target stand according to claim 1, wherein the primary stabilization rail further comprises a hole with a specifically machined connector on each proximal end for further connecting additional target stands.

6. The target stand according to claim 1, wherein the plurality of legs are vertically protrudeable in nature to increase a height of the primary stabilization rail resulting vertical adjustment of the target structure.

7. The target stand according to claim 1, wherein the primary stabilization rail, the secondary stabilization rail, the ballistic metallic plate, the plurality of leg receiving brackets and the plurality of legs have a thickness of 0.375 inches.

8. The target stand according to claim 1, wherein the primary stabilization rail, the secondary stabilization rail, the plurality of leg receiving brackets and the plurality of legs are made up of mild steel.

9. The target stand according to claim 1 is expanded by connecting the primary stabilization rail with another primary stabilization rail of another target stand in a lateral direction as well as longitudinal direction.

10. The target stand according to claim 1, wherein the plurality of accessories and the plurality of target structures are connected to the primary stabilization rail through a locking mechanism comprising a thread locking, a vacuum grip locking, a sliding grip locking, and a plug-in locking.
